(19) United States
(12) Patent Application Publication
(10) Pub. No.: US 2016/0112907 A1
(43) Pub. Date: Apr. 21, 2016

(54) USER EQUIPMENT BASED PSEUDO-RESELECTION

(71) Applicant: QUALCOMM Incorporated, San Diego, CA (US)

(72) Inventors: Thawatt GOPAL, San Diego, CA (US); Reza SHAHIDI, San Diego, CA (US); Mungal Singh DHANDA, Slough (GB); Thiagarajan SIVANADYAN, Boulder, CO (US); Bhanu Kiran JANGA, Hyderabad (IN); Zhang ZHOU, San Diego, CA (US); Tom CHIN, San Diego, CA (US)

(21) Appl. No.: 14/616,583

(22) Filed: Feb. 6, 2015

Related U.S. Application Data
(60) Provisional application No. 62/064,908, filed on Oct. 16, 2014.

(51) Int. Cl. H04W 36/00

(52) U.S. Cl. CPC H04W 36/0072; H04W 88/02

(57) ABSTRACT

User equipment (UE) based pseudo-reselection occurs from a first wireless cell to a second wireless cell. A UE autonomously discovers candidate reselection frequencies and autonomously sets reselection thresholds. The UE perform cell reselection based on the discovered candidate cell reselection frequencies and the autonomously set thresholds.

### CROSS-REFERENCE TO RELATED APPLICATION

This application claims the benefit under 35 U.S.C. §119(e) to U.S. Provisional Patent Application No. 62/064,908 entitled “USER EQUIPMENT BASED PSEUDO-RESELECTION,” filed on Oct. 16, 2014, the disclosure of which is expressly incorporated by reference herein in its entirety.

### BACKGROUND

1. Field

Aspects of the present disclosure relate generally to wireless communication networks, and more particularly, to user equipment (UE) based pseudo-reselection from a first wireless cell to a second wireless cell.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA), that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

In one aspect, a method of wireless communication is disclosed. The method includes autonomously discovering candidate reselection frequencies and radio access technology (RAT) information of at least one target cell. The method also includes autonomously setting reselection thresholds. Additionally, the method includes performing cell reselection based at least in part on the discovered candidate reselection frequencies and RAT information and the reselection threshold.

Another aspect discloses an apparatus including means for autonomously discovering candidate reselection frequencies and radio access technology (RAT) information of at least one target cell. The apparatus also includes mean for autonomously setting reselection thresholds. Additionally, the apparatus includes means for performing cell reselection based at least in part on the discovered candidate reselection frequencies and RAT information and the reselection threshold.

Another aspect discloses wireless communication having a memory and at least one processor coupled to the memory. The processor(s) is configured to autonomously discover candidate reselection frequencies and radio access technology (RAT) information of at least one target cell. The processor(s) is also configured to autonomously set reselection thresholds. Additionally, the processor(s) is configured to perform cell reselection based at least in part on the discovered candidate reselection frequencies and RAT information and the reselection threshold.

In another aspect, a computer program product for wireless communications in a wireless network having a non-transitory computer-readable medium is disclosed. The computer-readable medium has non-transitory program code recorded thereon which, when executed by the processor(s), causes the processor(s) to perform operations of autonomously discovering candidate reselection frequencies and radio access technology (RAT) information of at least one target cell. The program code also causes the processor(s) to autonomously set reselection thresholds. Additionally, the program code causes the processor(s) to perform cell reselection based at least in part on the discovered candidate reselection frequencies and RAT information and the reselection threshold.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates network coverage areas according to aspects of the present disclosure.

FIG. 5 is a block diagram illustrating a method for pseudo reselection to a neighbor cell according to one aspect of the present disclosure.

FIG. 6 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

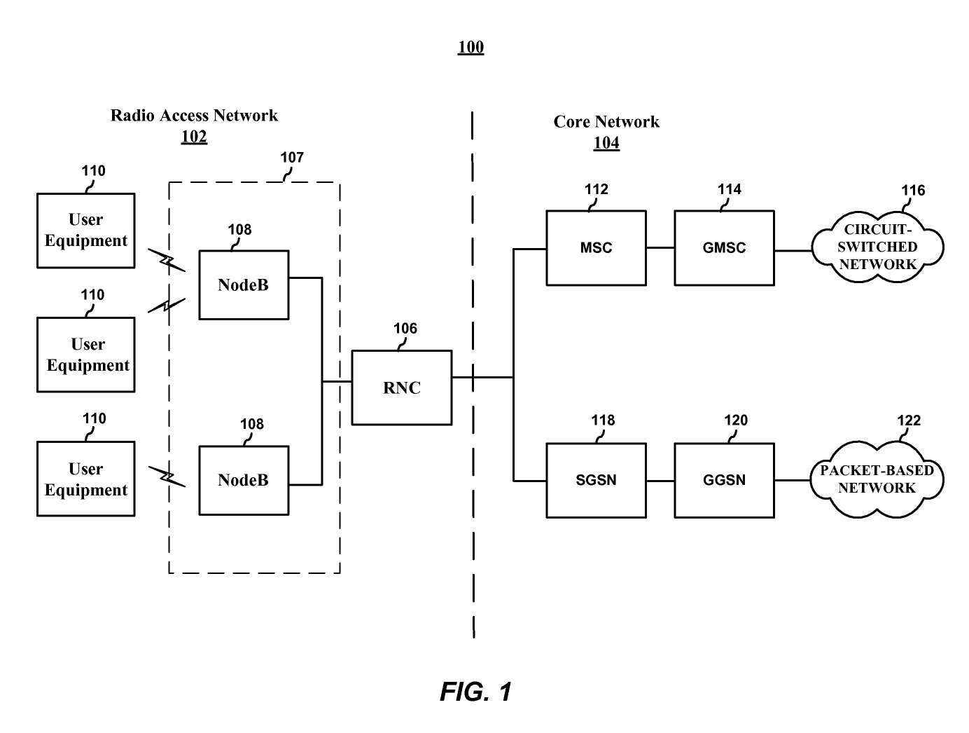

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

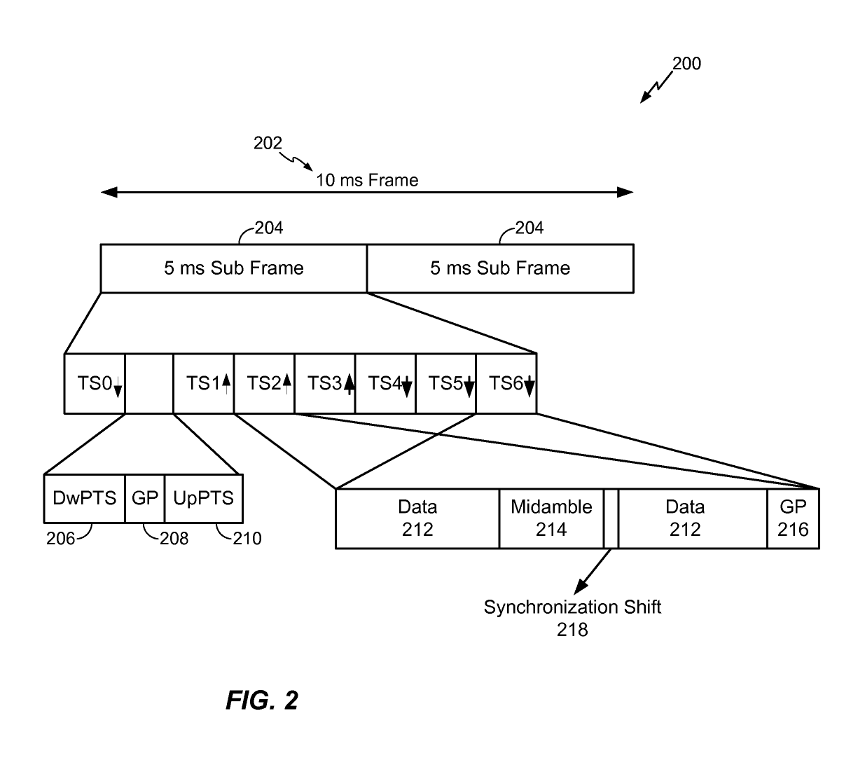

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including synchronization shift (SS) bits 218. Synchronization shift bits 218 only appear in the second part of the data portion. The synchronization shift bits 218 immediately following the midamble can indicate three cases: decrease shift, increase shift, or do nothing in the upload transmit timing. The positions of the synchronization shift bits 218 are not generally used during uplink communications.

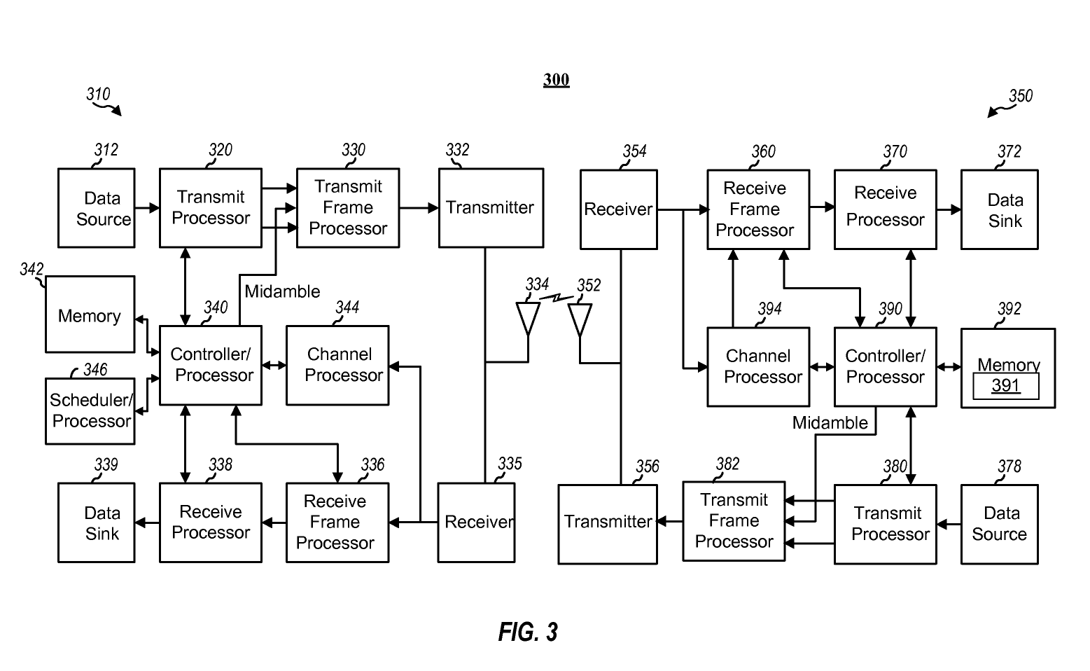

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receive processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames. Additionally, a scheduler/processor 346 at the node B 310 may be used to allocate resources to the UEs and schedule downlink and/or uplink transmissions for the UEs.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer-readable media of memory may store data and software for the UE 350. For example, the memory 392 of the UE 350 may store a pseudo-cell reselection module 391 which, when executed by the controller/processor 390, configures the UE 350 for performing cell reselection.

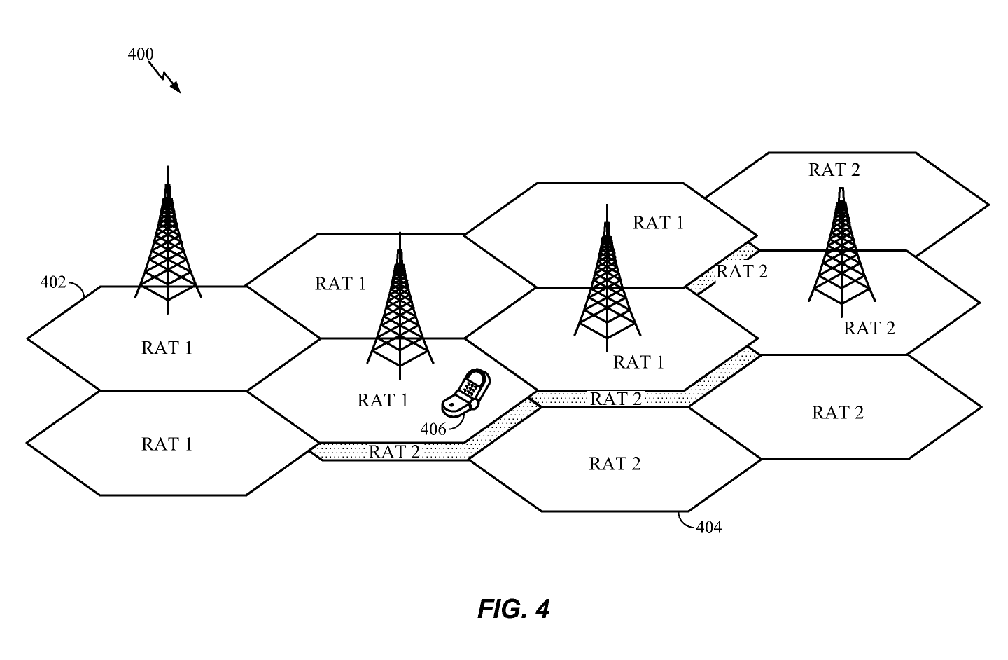

Some networks, such as a newly deployed network, may cover only a portion of a geographical area. Another network, such as an older more established network, may better cover the area, including remaining portions of the geographical area. FIG. 4 illustrates coverage of an established network utilizing a first type of radio access technology (RAT-1), and a second type of RAT. The RATs may be any type of technology, such as, but not limited to GSM, LTE, TD-SCDMA and high speed data networks.

The geographical area 400 may include RAT-1 cells 402 and RAT-2 cells 404. In one example, the RAT-1 cells are LTE cells and the RAT-2 cells are TD-SCDMA cells. However, those skilled in the art will appreciate that other types of radio access technologies may be utilized within the cells. A user equipment (UE) 406 may move from one cell, such as a RAT-1 cell 404, to another cell, such as a RAT-2 cell 402. The movement of the UE 406 may specify a handover or a cell reselection.

The handover or cell reselection may be performed when the UE moves from a coverage area of a first RAT to the coverage area of a second RAT, or vice versa. A handover or cell reselection may also be performed when there is a coverage hole or lack of coverage in one network or when there is traffic balancing between a first RAT and the second RAT networks. As part of that handover or cell reselection process, while in a connected mode with a first system (LTE) a UE may be specified to perform a measurement of a neighboring cell (TD-SCDMA). For example, the UE may measure the neighbor cells of a second network for signal strength, frequency channel, and base station identity code (BSIC). The UE may then connect to the strongest cell of the second network. Such measurement may be referred to as inter radio access technology (IRAT) measurement.

The UE may send a serving cell a measurement report indicating results of the IRAT measurement performed by the UE. The serving cell may then trigger a handover of the UE to a new cell in the other RAT based on the measurement report. The measurement may include a serving cell signal strength, such as a received signal code power (RSCP) for a pilot channel (e.g., primary common control physical channel (PCCPCH)). The signal strength is compared to a serving system threshold. The serving system threshold can be indicated to the UE through dedicated radio resource control (RRC) signaling from the network. The measurement may also include a neighbor cell received signal strength indicator (RSSI). The neighbor cell signal strength can be compared with a neighbor system threshold. Before handover or cell reselection, in addition to the measurement processes, the base station IDs (e.g., BSICs) are confirmed and re-confirmed.

Handover from the first RAT to the second RAT may be based on event 3A measurement reporting. In one configuration, the event 3A measurement reporting may be triggered based on filtered measurements of the first RAT and the second RAT, a base station identity code (BSIC) confirm procedure of the second RAT and also a BSIC re-confirm procedure of the second RAT. For example, a filtered measurement may be a Primary Common Control Physical Channel (P-CCPCH) or a Primary Common Control Physical Shared Channel (P-CCPSCH) received signal code power (RSCP) measurement of a serving cell. Other filtered measurements can be of a received signal strength indication (RSSI) of a cell of the second RAT.

### UE Based Pseudo Reselection

In specification-based cell reselection, the base station sends target cell information, such as the target frequency(s) and reselection parameters, over a broadcast channel to a user equipment (UE). The UE utilizes the broadcast information to perform the reselection measurements, reselection evaluation and for triggering reselection from one cell to a different cell that either belongs to the same RAT (radio access technology) or a different RAT.

For example, in a TD-SCDMA to LTE IRAT-based cell reselection, target cell information is broadcast in the system information block (SIB) 19. The target cell information may include, but is not limited to reselection frequency(ies) and reselection parameters. When this information is not provided, it is not possible to perform the specification-based reselection procedure.

In another example, in a GSM to LTE IRAT-based cell reselection, the information (i.e., reselection frequency and parameters) is broadcast in the system information 2-quarter (SI-2qtr). In GSM to TD-SCDMA IRAT-based cell reselection, the information (i.e., reselection frequency and parameters) is broadcast in both the system information 2-quarter (SI-2qtr) and the system information 2-ter (SI-2ter). When this information is not provided, it is not possible to perform the specification-based reselection procedure.

One aspect of the present disclosure is directed to enabling reselection when reselection frequencies and parameters are not provided to the UE. This also includes scenarios when the correct information is not provided to the UE. In one aspect, the UE generates, on its own, the reselection parameters, which may include, but are not limited to at least one cell reselection frequency, i.e., target cell frequency information and various types of reselection threshold information. The UE utilizes the reselection parameters it generates to perform cell reselection, which may also be referred to as a UE-based pseudo-reselection. The pseudo-reselection may apply to, but is not limited to, TD-SCDMA to LTE, GSM to LTE, GSM to TD-SCDMA, and WCDMA to LTE pseudo-reselections.

In one aspect of the present disclosure, the UE discovers target RATs and/or frequencies for reselection of at least one target cell. The UE may utilize various mechanisms for discovering the potential frequencies for performing reselection. For example, after a successful redirection from a source cell to a target RAT/frequency occurs, the UE stores the global cell identification (ID) of the source cell in a local database of the UE. The local database is then updated with the source cell's global cell identification (ID) and the successful redirection RAT/frequency information.

Additionally, after a successful handover from a source cell to target RAT/frequency occurs, the source cell's global cell ID is stored in a local database. Further, the local database is updated with the source cell global cell ID and the successful handover RAT/frequency information. That is, storing successful handover target frequencies occurs.

The possible candidate frequencies for reselection may be discovered via a background scan of frequencies, i.e., the target RAT/system. The scanning method may be enabled when the UE is camped on particular public land mobile network (PLMN) IDs and when the feature is desired by the operator. The background scan may be limited to frequency bands associated with a particular operator and may be based on checking the PLMN ID of the camped UE where the scan is triggered. In one aspect, each of the discovered frequencies is stored in a local database. Alternately, only frequencies meeting particular criteria are stored in the local database. For example, the UE may only store those discovered frequencies belonging to a list of PLMN IDs associated with the global cell ID where the background scan results were received. In one example, the target RAT/system is LTE and the background scan is scanning for LTE. There are more than forty (40) frequency bands in the LTE specifications. Scanning for bands associated with the operator via associated PLMN IDs significantly reduces the time and power consumption for detecting valid target frequencies.

Additionally, the UE may autonomously discover reselection thresholds. In particular, a background scan may be performed once certain criteria have been met. The criteria, for example, may include, but is not limited to, matching a camped PLMN ID to a list of stored PLMN IDs associated with operators who want to turn on this feature. Further, the background scan is customized to frequency bands associated with an intended operator.

In another aspect of the present disclosure, the UE creates pseudo-reselection parameters for enabling reselection to a target system when no specification-based system information is broadcast by the network. The pseudo-reselection parameters may include, but are not limited to, relevant frequency lists and reselection thresholds at the UE. The UE may autonomously set reselection thresholds based on the stored pseudo-reselection parameters. Further, when a camped cell does not broadcast relevant (or accurate) system information on the broadcast channel for enabling the specification-based cell reselections (e.g., SIB-19 for TD-SCDMA to LTE cell reselection, SI 2qtr for GSM to LTE cell reselection, etc.), the UE may then utilize the created pseudo-reselection parameters (including the set reselection thresholds) to enable reselection.

Additionally, the UE may utilize the pseudo-reselection parameters when the global cell ID of a camped cell has an entry of successfully discovered frequencies based on prior background scans, redirections or handovers. The UE may initiate the reselection procedure based on the locally cached information for reselection.

The UE stores, in a local database, a list of global cell IDs with associated discovered frequencies. The list is updated whenever there is a newly discovered frequency associated with an existing entry of a cell's global cell ID in the database due to background scan, redirection, handover procedure, etc.

Various reselection parameters may be stored in the UE's local database to enable the pseudo-reselection. A global cell identification (ID) uniquely identifies each serving cell. Pseudo-reselection parameters are stored for each global cell ID listed in the database. Thus, for each global cell ID, information is stored for that serving cell as well as associated neighbor cells. The pseudo-reselection parameters may include reselection parameters for the UE and also information related to the target cells.

For each serving cell, the UE reselection parameters may include the priority of a network and thresholds for triggering search and measurement procedures. For example, a threshold for priority based search and measurement may be stored. In addition, an alternative threshold may be stored and utilized when the priority is not known. The stored information may be set as default values.

The database also stores additional information for the neighbor cells, such as, but not limited to channel information, measurement bandwidth, detection parameters, priority information, and various threshold information, including signal strength thresholds. For LTE, the channel information may include the evolved absolute radio frequency channel number (EARFCN) and may be obtained from the database discussed above, which may be built upon the UE's prior discovered frequencies from background scans, redirection and handover.

The priority information indicates the priority of the neighbor RAT and/or frequency. The configured priority is generally associated with a frequency. The various threshold information may include a high reselection threshold and a low reselection threshold, for example, to be used when the neighbor cell is high priority or low priority, respectively. The database also stores a threshold for the minimum receive signal strength level that is sufficient for camping on the frequency associated with a particular intra or inter-RAT target. These parameters may be assigned default values.

By enabling pseudo cell reselection, the reselection process can occur without (or with inaccurate) broadcast reselection information. Moreover, the pseudo-reselection process can consume less power. Finally, the pseudo-reselection process enables shorter measurement times.

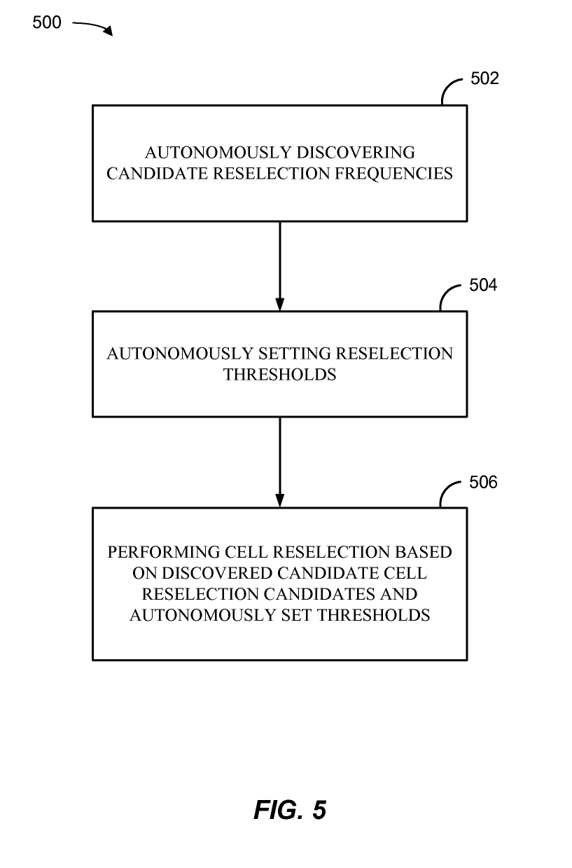

FIG. 5 shows a method of wireless communication 500 in a wireless network, according to one aspect of the disclosure. A UE autonomously discovers candidate reselection frequencies of a target cell(s), as shown in block 502. The UE also autonomously sets reselection thresholds, as shown in block 504. In block 506, the UE performs cell reselection based at least in part on the discovered candidate cell reselection frequencies and the autonomously set thresholds.

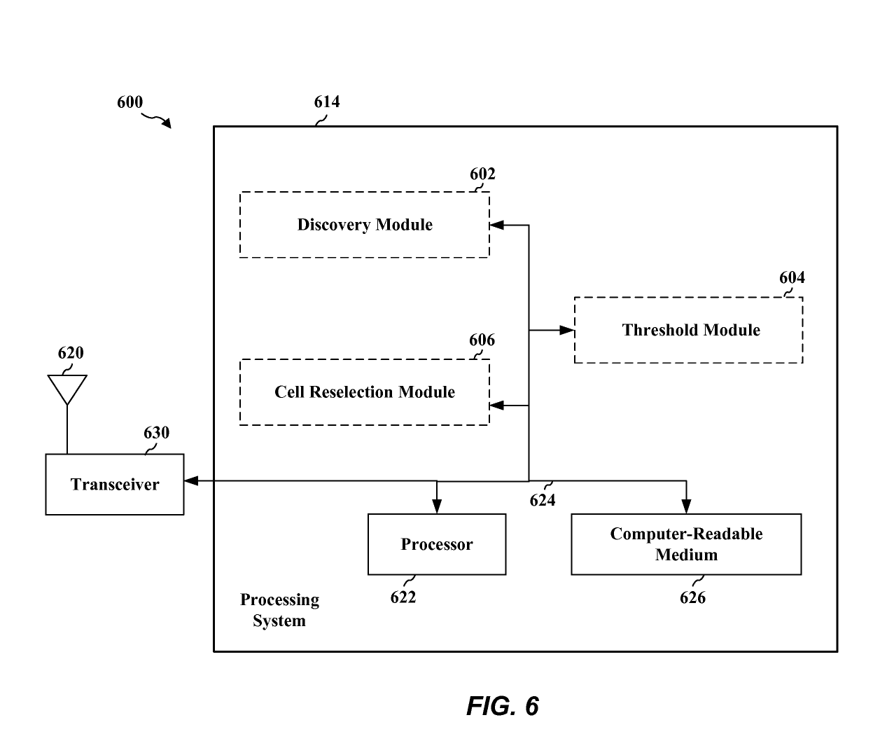

FIG. 6 is a diagram illustrating an example of a hardware implementation for an apparatus 600 employing a processing system 614. The processing system 614 may be implemented with a bus architecture, represented generally by the bus 624. The bus 624 may include any number of interconnecting buses and bridges depending on the specific application of the processing system 614 and the overall design constraints. The bus 624 links together various circuits including at least one processor and/or hardware modules, represented by the processor 622 the modules 602, 604, 606 and the non-transitory computer-readable medium 626. The bus 624 may also link various other circuits such as timing sources, peripherals, voltage regulators, and power management circuits, which are well known in the art, and therefore, will not be described any further.

The apparatus includes a processing system 614 coupled to a transceiver 630. The transceiver 630 is coupled to one or more antennas 620. The transceiver 630 enables communicating with various other apparatus over a transmission medium. The processing system 614 includes a processor 622 coupled to a non-transitory computer-readable medium 626. The processor 622 is responsible for general processing, including the execution of software stored on the computer-readable medium 626. The software, when executed by the processor 622, causes the processing system 614 to perform the various functions described for any particular apparatus. The computer-readable medium 626 may also be used for storing data that is manipulated by the processor 622 when executing software.

The processing system 614 includes a discovery module 602 for discovering candidate reselection frequencies. The processing system 614 includes a threshold module 604 for autonomously setting reselection thresholds. The processing system 614 includes a cell reselection module 606 for performing cell reselection. The modules may be software modules running in the processor 622, resident/stored in the computer-readable medium 626, one or more hardware modules coupled to the processor 622, or some combination thereof. The processing system 614 may be a component of the UE 350 and may include the memory 392, and/or the controller/processor 390.

In one configuration, an apparatus such as a UE is configured for wireless communication including means for discovering. In one aspect, the discovering means may be the antennas 352, the receiver 354, the channel processor 394, the receive frame processor 360, the receive processor 370, the controller/processor 390, the memory 392, pseudo-cell reselection module 391, discovery module 602, and/or the processing system 614 configured to perform the discovery means. The UE is also configured to include means for autonomously setting reselection thresholds. In one aspect, the autonomously setting means may be the controller/processor 390, the memory 392, the pseudo-cell reselection module 391, threshold module 604, and/or the processing system 614 configured to perform the autonomously setting means. The UE is also configured to include means for performing. In one aspect, the performing means may be the antennas 352, the receiver 354, the channel processor 394, the receive frame processor 360, the receive processor 370, the transmitter 356, the transmit frame processor 382, the transmit processor 380, the controller/processor 390, the memory 392, pseudo-cell reselection module 391, cell reselection module 606, and/or the processing system 614 configured to perform the performing means.

The UE may also be configured to include a means for determining at least one cell

In one configuration, the means functions correspond to the aforementioned structures. In another aspect, the aforementioned means may be a module or any apparatus configured to perform the functions recited by the aforementioned means.

Several aspects of a telecommunications system has been presented with reference to TD-SCDMA, GSM and LTE. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

It is also to be understood that the term “signal quality” is non-limiting. Signal quality is intended to cover any type of signal metric such as received signal code power (RSCP), reference signal received power (RSRP), reference signal received quality (RSRQ), received signal strength indicator (RSSI), signal to noise ratio (SNR), signal to interference plus noise ratio (SINR), etc.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
autonomously discovering candidate reselection frequencies and radio access technology (RAT) information of at least one target cell;
autonomously setting reselection thresholds; and
performing cell reselection based at least in part on the discovered candidate reselection frequencies and RAT information and the reselection thresholds.

2. The method of claim 1, in which the discovering comprises performing a background scan of frequencies associated with an operator of a serving cell.

3. The method of claim 1, in which the discovering comprises storing successful handover target frequencies and/or successful redirection target frequencies.

4. The method of claim 1, further comprising determining that at least one cell reselection frequency received over air is unavailable prior to discovering and autonomously setting.

5. The method of claim 1, further comprising updating discovered candidate reselection frequencies stored in a user equipment (UE) memory.

6. An apparatus for wireless communication, comprising:
means for autonomously discovering candidate reselection frequencies and radio access technology (RAT) information of at least one target cell;
means for autonomously setting reselection thresholds; and
means for performing cell reselection based at least in part on the discovered candidate reselection frequencies and RAT information and the reselection thresholds.

7. The apparatus of claim 6, in which the means for autonomously discovering comprises performing a background scan of frequencies associated with an operator of a serving cell.

8. The apparatus of claim 6, in which the means for autonomously discovering comprises means for storing successful handover target frequencies and/or successful redirection target frequencies.

9. The apparatus of claim 6, further comprising means for determining that at least one cell reselection frequency received over air is unavailable prior to discovering and autonomously setting.

10. The apparatus of claim 6, further comprising means for updating discovered candidate reselection frequencies stored in a user equipment (UE) memory.

11. An apparatus for wireless communication, comprising:
a memory; and
at least one processor coupled to the memory, the at least one processor being configured:
to autonomously discover candidate reselection frequencies and radio access technology (RAT) information of at least one target cell;
to autonomously set reselection thresholds; and
to perform cell reselection based at least in part on the discovered candidate reselection frequencies and RAT information and the reselection thresholds.

12. The apparatus of claim 11, in which the at least one processor is configured to autonomously discover by performing a background scan of frequencies associated with an operator of a serving cell.

13. The apparatus of claim 11, in which the at least one processor is configured to autonomously discover by storing successful handover target frequencies and/or successful redirection target frequencies.

14. The apparatus of claim 11, in which the at least one processor is further configured to determine that at least one cell reselection frequency received over air is unavailable prior to discovering and autonomously setting.

15. The apparatus of claim 11, in which the at least one processor is further configured to update discovered candidate reselection frequencies stored in the memory.

16. A computer program product for wireless communication in a wireless network, comprising:
a non-transitory computer-readable medium having non-transitory program code recorded thereon, the program code comprising:
program code to autonomously discover candidate reselection frequencies and radio access technology (RAT) information of at least one target cell;
program code to autonomously set reselection thresholds; and
program code to perform cell reselection based at least in part on the discovered candidate reselection frequencies and RAT information and the reselection thresholds.

17. The computer program product of claim 16, in which the program code is configured to autonomously discover by performing a background scan of frequencies associated with an operator of a serving cell.

18. The computer program product of claim 16, in which the program code is configured to autonomously discover by storing successful handover target frequencies and/or successful redirection target frequencies.

19. The computer program product of claim 16, in which the program code further comprises program code to determine that at least one cell reselection frequency received over air is unavailable prior to discovering and autonomously setting.

20. The computer program product of claim 16, in which the program code further comprises program code to update discovered candidate reselection frequencies stored in a user equipment (UE).
